(19) United States
(12) Patent Application Publication
(10) Pub. No.: US 2008/0133696 A1
(43) Pub. Date: Jun. 5, 2008

(54) PERSONAL MULTI-MEDIA PLAYING SYSTEM

(76) Inventor: Hanns-Christian Leemon Hanebeck, Carrollton, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/566,278

(22) Filed: Dec. 4, 2006

(51) Int. Cl. G06F 15/16

(52) U.S. Cl. 709/217

(57) ABSTRACT

A method and system are provided which enables personal, user-defined programming by allowing a user to select, store and retrieve media programming according to the user's personal preferences. In an exemplary embodiment, a user is enabled to define, select and refine channels by categories, such as “sports”, “news” and “music”, inter alia. A favorites list or playlist is used to provide a listing for types of audio programs in an order of preference of the user. The audio system enables user personal feedback on actual audio program presentations and which is selectively used to automatically update the user's favorites listing of audio information programming preferences. The user is enabled to input commands, both manually or verbally, to change audio presentations in an order of user priority as presented on the automatically updated favorites listing.

### FIELD OF THE INVENTION

The present invention relates generally to information processing systems and more particularly to a system and methodology for processing digital audio signals.

### BACKGROUND OF THE INVENTION

In the rapidly changing world of telecommunications and electronics in general, the concepts of radio that exist today are not much different from those in existence in the early part of the twentieth century. Despite the advent of physical media which enable a user to carry the music to which the user wishes to listen, the concept of radio still exists in a format offering users very few options. Although a user may choose a station or several stations which may be preferred by the user, there are no current options which enable users to listen to preferred music selections, for example, at the user's convenience rather than on the timetables provided by the local broadcasters.

Moreover, it is always frustrating for a user to switch among radio stations in an effort to find a music type or information type selections preferred by the user. The advent of the Internet in recent years has led to a proliferation of changes in our lives ranging from access to immense amounts of data, information and knowledge to the ability to transact and interact in ways that have never been possible before. Yet, radio broadcasts have remained virtually untouched by the advent and development of the Internet. Users are still only able to mechanically pre-select stations that may or may not play audio content preferred by a user.

Thus, there is a need for an improved digital processing system which provides a greater degree of selective audio control by users of radio and other transmitted signal content.

### SUMMARY OF THE INVENTION

A method and preference processing system (PPS) are provided which enables personal, user-defined programming of media presentations such as audio or video presentations. In an exemplary embodiment, a user is enabled to define, select and refine channels by categories, such as “sports”, “vnews” and “music”, inter alia. A favorites list or playlist is used to provide a listing for types of audio or video media programs in an order of preference of the user. The media presentation system enables user personal feedback on actual audio or video program presentations and the personal feedback is selectively used to automatically update the user's favorites listing of audio or video information programming preferences. In another exemplary embodiment, the user is further enabled to input commands, both manually or verbally, to change audio or video presentations in an order of user priority as presented on the automatically updated favorites listing.

### BRIEF DESCRIPTION OF THE DRAWINGS

A better understanding of the present invention can be obtained when the following detailed description of a preferred embodiment is considered in conjunction with the following drawings, in which:

FIG. 1 is a block diagram of a receiving device implemented in accordance with the present invention;

FIG. 2 is a block diagram of the Internet-enabled wireless system in accordance with the present invention;

FIG. 3 is an illustration of an exemplary arrangement for enabling user-feedback or voting on currently playing audio presentations;

FIG. 4 flowchart showing an exemplary overall operational sequence in one implementation of the present invention;

FIG. 5 is a continuation of FIG. 4;

FIG. 6 is a flowchart showing an exemplary functional sequence for creating a personal profile and playlist of audio preferences;

FIG. 7 is a flowchart showing an exemplary functional sequence for changing a user's personal profile and preferences;

FIG. 8 is a flowchart showing an exemplary functional sequence for enabling user update of audio preferences; and

FIG. 9 is a flowchart showing an exemplary functional sequence for creating a user playlist of personal audio preferences.

### DETAILED DESCRIPTION

It is noted that circuits, devices and flow functions which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. It is further noted that the following example is illustrated as applied to an audio device although the present invention applies equally well to other media presentations, including video presentations, which can be made on a personal wireless media device.

An exemplary embodiment of the present invention includes a system that takes input from a user in regard to audio preferences, creates a profile of audio preferences, compares these preferences against a large number of content items based on pre-defined characteristics and then produces a stream of customized content based on the initial set of user preferences as well as based on user feedback during the consumption of the broadcast. The disclosed system includes a hand-held radio device that includes a wireless receiver (e.g. UMTS, W-CDMA, 802.16) and also a voting mechanism which allows the user to express like and dislike of audio pieces, including advertising content, through buttons or a scale of preferences. The present invention may also be implemented to include the ability to convert written text e.g. in blogs or on websites, into spoken voice and to stream this content to the radio user as well.

A typical process begins when a user logs on to a system such as a website or a database to express the user's preferences for a specific content category. Potential categories include news, music or cultural programs to name a few examples. The system then creates a profile for the user and saves as many preferences as possible. Next, the system will create a playlist based on items that are closest to the user preferences which already exist on the system. A practical example from the music industry is that a user expresses a specific preference for music from a specific band or group. The system will now find as many songs as possible that share some or all of the characteristics that it has stored and associated with the specified band. This process is also applicable to news and other content items such as sports, weather or stock market performances. As used herein, the term “characteristics” includes, but is not limited to, tangible and intangible factors which allow for the establishment of similarity between two or more songs, newscasts or sports broadcasts, for example. In some cases this may include only “keywords” such as “news” or “sports” while in other cases, such as music or cultural programming, it may be a combination of factors such as, inter alia, rhythm, instrument or vocal, frequencies of instruments, etc., to name but a few examples of music characteristics which may be used to determine “similarity”. The user is also able to register a wireless device with the system. Once the initial registration is complete, the user can take the wireless device and connect to the system through the wireless network. The user will be able to log onto the system through her device and initiate the download of content. The device may also allow the user to switch between categories that can be predefined or determined by the user's profile on the system. Further, the device has a “voting feature” that allows the user to provide feedback to the system through the expression of “like-dislike” or scale agreement with the content that is currently playing or has finished playing very recently. The device itself can take a plurality of inputs including buttons, menus or voice controls. In some instances, it may also be beneficial for the user to indicate new or emerging preferences on the device rather than in the system. The voting mechanism is also available on the system itself where a user could vote on a block of past content in a single session without having to bother with voting on each piece of content. One extension of such a system and device is through the inclusion of advertising and marketing content. A number of offerings are presented to the user based on explicit inclusion (the user chooses advertisers from a list in the system) or implicit inclusion (based on the user's musical and other content tastes). The advertiser or marketer can reward the user for listening to content by paying for the service, the device, direct monetary payments or through coupons as well as any combination. For those cases, where the user does not explicitly state preferences or tastes, the system includes a database that can connect service offerings to expressed user preferences, e.g. users listening to “Country & Western” music have certain known and common purchase preferences.

Another feature of the invention is the provision of content that is available on the web through text analysis and conversion of text into spoken language. The user may indicate a preference for certain blogs, wikis or other content areas and receive such content in the same fashion as described above. The system creates a link to a site such as Wikipedia and allow users to express an interest in a selected category and receive a multitude of entries related to that topic over time. The user may also indicate how much each specific content or category item should be weighted, e.g. “10% news, 10% sports, 10% trivia (Wikidepia entries) and 70% music based on the user's predetermined preferences”.

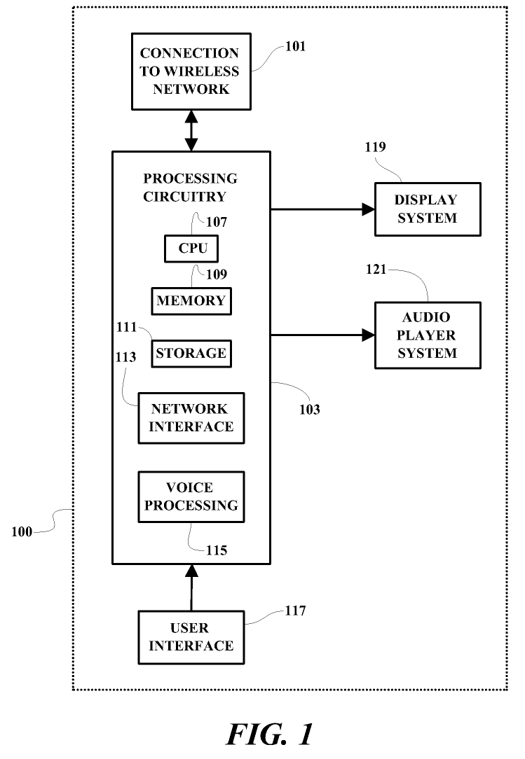

With specific reference to FIG. 1, the various methods discussed herein may be implemented with an audio device 100 which illustrates only one of many possible exemplary embodiments of the present invention. The audio device 100 is arranged to receive broadcast signals from a wireless broadcast station and also to communicate with a content server through an interconnection network such as the Internet. The signals received through a network interface 113 within the audio device 100 include signals which may originate from local broadcast stations and/or satellite systems. As is hereinafter discussed in greater detail, the disclosed personal audio system includes content categories specifically selected by the user of the device 100. This received audio content is specifically selected for the specific user and only the user of the device 100 is enabled to receive the custom-created radio or other broadcast signal content.

The digitized data streams are received by the audio device 100 through a connection to a wireless network 101 and are applied to processing circuitry 103 which includes one or more CPUs 107, a memory unit 109, storage 111, a network interface 113 and voice processing circuitry 115. The storage device may be any type of non-volatile memory including flash memory. The voice processing circuitry 115 enables synthesized voiced announcements to be made and also enables direct user input through voiced commands. Voiced inputs as well as push-button inputs and software menu-enabled user inputs are processed through a user input or interface unit 117. All of the functional blocks within the processing circuitry 103 are connected together by a common system bus. The system is designed to enable a user, inter alia, to input information using a voiced input to the voice processing module 115 and the device may also include a keypad in the user interface 117 for menu-driven manual input.

Outputs from the processing circuitry 103 are provided to a display module 119, and also as played station audio output to a speaker system 121 of an audio player. The display device 119 may comprise, for example, a liquid crystal display (LCD) which is viewable by a user in a motor vehicle or a stand-alone radio or other wireless audio device.

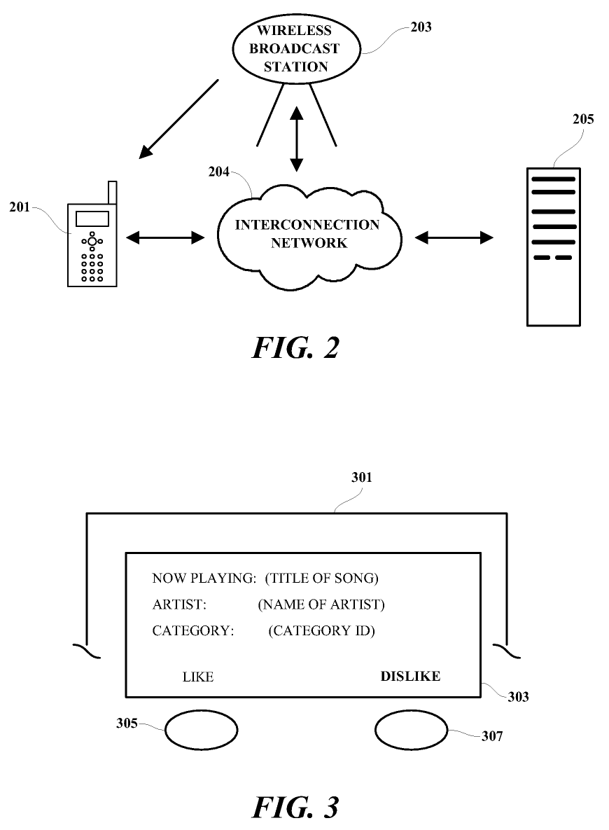

As shown in FIG. 2, in one example, an audio receiver/player device 201 is enabled to receive and play audio content which is transmitted from a server unit 205 over an interconnection network 204, such as the Internet or a Virtual Private Network (VPN), to the wireless broadcast station 203 and then to the connection to the wireless network 101 of the audio device 201. The content server 205 is also coupled to radio broadcast stations 203 for selective access to radio broadcast channels at the user's option in the event the user wishes to listen to a favorite radio station from a foreign country, for example, on the personal audio device 201 without having to use satellite radio.

FIG. 3 illustrates an exemplary display device 301 including a display screen 303. While an audio piece is playing on the device 301, the screen 303 may display, for example, the title of the song (or other content) currently playing, as well as the Artist and the Category of the audio content, e.g. Country & Western Music, News Headlines, Weather, etc. The device 301 also includes “Like/Dislike” buttons 305 and 307, which may be implemented in any of many software or hardware configurations. As a specific audio piece is playing, the user is enabled to actuate either the “Like” button 305 or the “Dislike” button 307. This user preference is saved for subsequent transmittal back to the server 205 over the interconnection network 204. In this manner a database of the user's likes and dislikes is obtained and used to modify an existing user preference list of preferred audio content as is hereinafter discussed in greater detail. The user preference data may be transmitted back to the content server 205 at the time the user input is made or saved on the audio device 301 and transmitted back to the content server 205 at a later time.

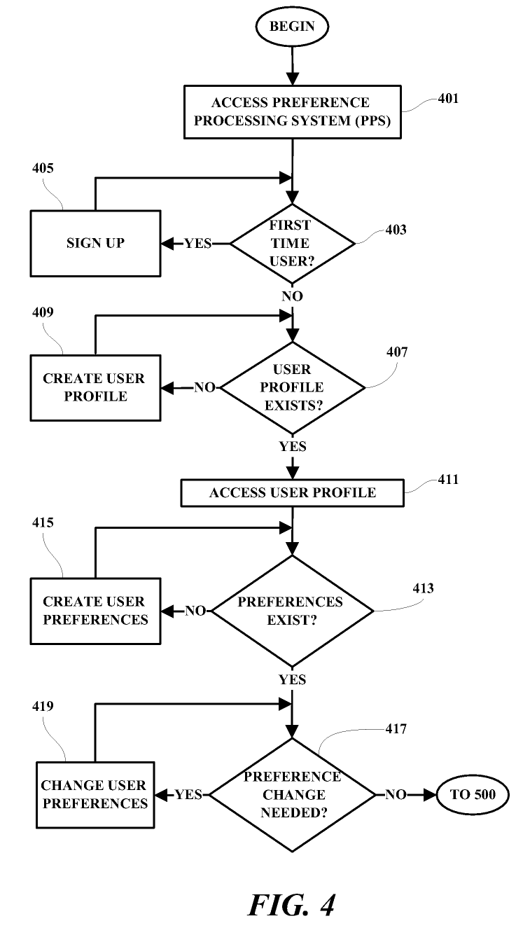

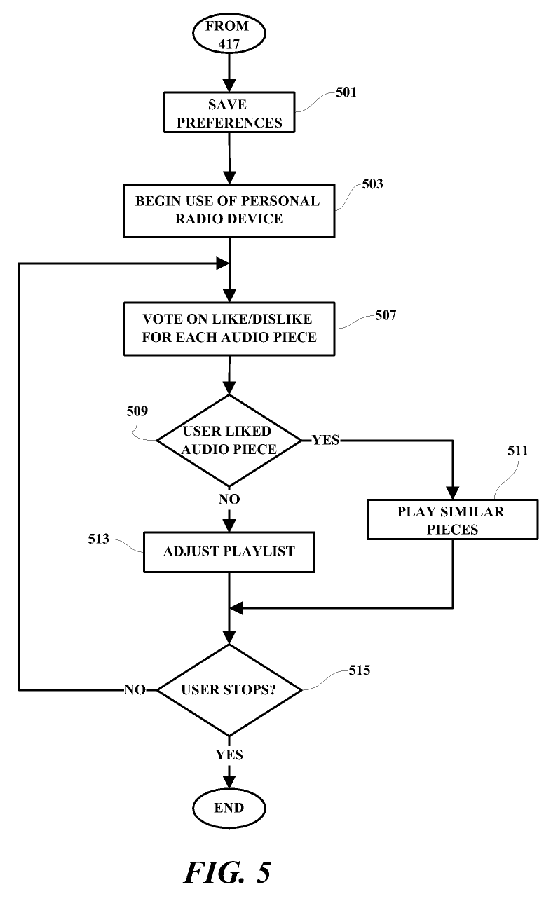

FIG. 4 illustrates an overall operation of an exemplary implementation of the present invention. As shown, when a user first logs on to the content server 205, the processing begins by accessing the preference processing system (PPS) 401. The PPS then determines if the user is a first time user 403 of the system and if so, the user goes through a sign-up process 405. Next, the system determines if a user preference profile exists 407 and if not, then the user is prompted for information input to create a user data profile 409. Next, the user profile is accessed 411 to determine if user audio piece preferences exist 413 and if not, then the user is prompted to input specific user preferences 415 with regard to audio categories such as “News”, “Music Types”, “Traffic”, etc. The user preferences may then be displayed to the user and the user is enabled to change 417 any of the preferences 419. The processing then continues as shown in FIG. 5.

As shown in FIG. 5, the user preferences are saved 501 (either in the wireless device 201 or transmitted to and saved at the content server 205), and use of the personal radio device is initiated 503 and audio pieces, which are assembled into a playlist by the content server 205 as a result of the input user preferences, are played on the audio device 100. The audio device is enabled to store several audio pieces, in advance of playing the pieces, within the audio device itself in order to assure a smoother presentation of the audio pieces on the audio device. As each audio piece is played on the user's audio device 201, the user may vote or indicate a “like” or a “dislike” 507 for the currently playing audio piece as discussed earlier. If the user indicates a “like” 509, then the playlist is modified to play similar pieces 511. If the user indicates a “dislike” for a certain piece, then the playlist is adjusted 513 to delete similar audio pieces. The user is enabled to continue to “vote” on audio pieces playing on the audio device until the user stops the “like/dislike” processing 515 at which time the “like/dislike” voting process will end, although audio pieces may continue to be played on the user audio device 201 as received from the content server 205.

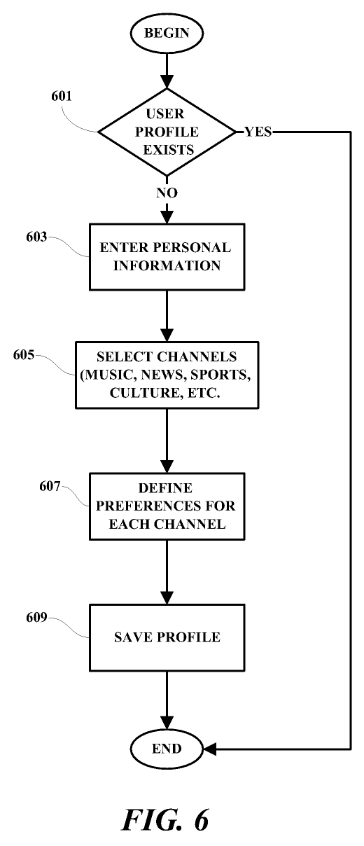

As shown in FIG. 6, when a user profile does not exist on the system 601, the user is prompted to enter personal information 603 and select channels 605 which are known to carry or broadcast specific categories of audio content. User preferences are defined for each channel 607 and when the profile has been created, it is saved 609 for future reference.

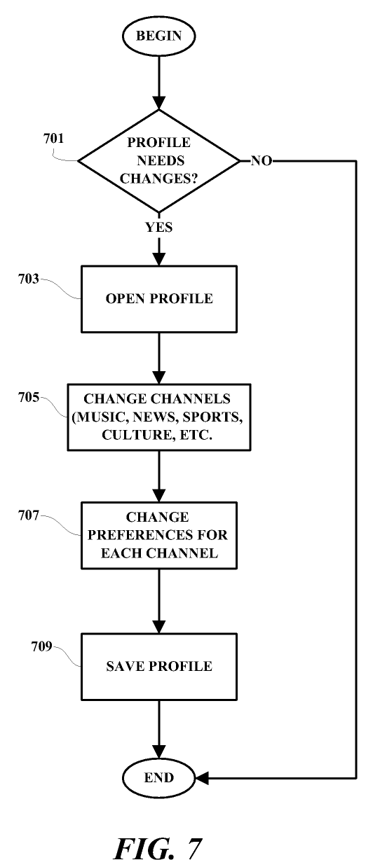

As shown in FIG. 7, when the user wishes to change the user's profile 701, the user's profile is accessed and opened 703 and the selected channels may be changed 705 as well as the preferences for each channel 707. The changed profile is then saved for future reference.

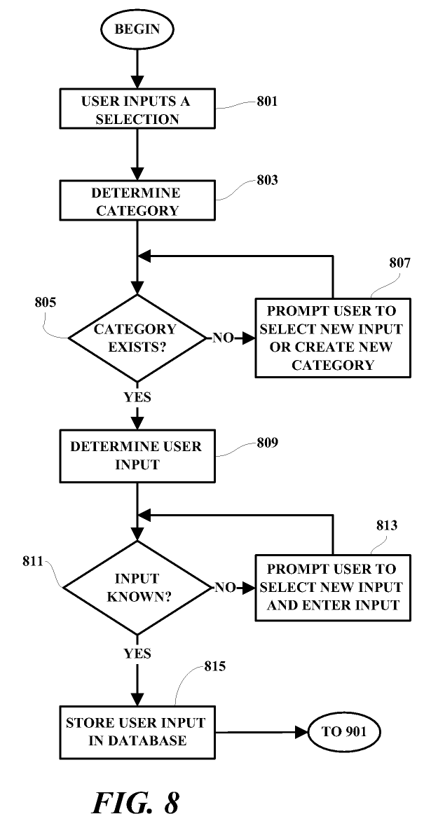

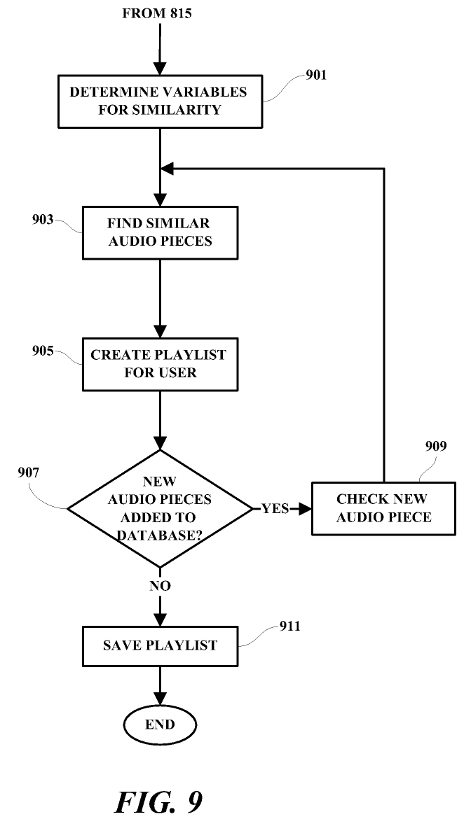

In selecting categories, as shown in FIG. 8, the user first inputs a selected audio piece 801 and the system determines a corresponding category 803. If a corresponding category does not exist, the user is prompted to select another category or create a new category 807. If the selected category exists 805, then the user is prompted to input more specific information 809 regarding audio pieces. If the user input is not known 811 then the user is prompted to select and enter a new input 813, otherwise the user input is stored in the user's database 815 and the process continues as shown in FIG. 9.

In FIG. 9, given the user's selections, the system determines variables for similarity 901. For example, for music pieces, measures of similarity may include beat, artist, instrumental or vocal, etc. Next, similar audio pieces to those selected by the user are identified by the system 903 and a playlist is created 905 for the user which includes specifically selected audio pieces as well as pieces determined to be similar using predetermined measures of similarity. The system then checks to see if new audio pieces have been added to the database by the user 907 and if so, a check is made to determine the similarity criteria for the new audio piece 909, and blocks 903, 905 and 907 are repeated until it is determined that all of the user's selected audio pieces have been processed for similar pieces available to the content server 205 at which point the playlist is saved 911 for future reference and the process ends.

It is noted that although the example illustrated herein refers to only to an audio device, other media presentations such as video files may also be broadcast to a similar wireless media device and the user is also enabled to indicate a “like” or a “dislike” for a video file being presented on the wireless media device. The “like” and “dislike” buttons may also correspond to other user inputs which may be presented on the display screen such as “yes” and “no”. For example a “yes” or “no” question may be transmitted to the media device and presented on the display and the user would be enabled to indicate a “yes” or “no” response which would be transmitted back to the server via the interconnection network.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in a memory medium, either volatile or non-volatile, from which it may be loaded or transmitted into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method comprising:
enabling a user of a media device to select categories of media content preferred by said user; and
transmitting only media pieces within said categories to said media device for playing on said media device.

2. The method as set forth in claim 1 wherein said media device is an audio device, said content being comprised of a playlist of individual audio pieces, said method further including:
enabling said user to provide a like/dislike indicium while said audio pieces are playing on said audio device, said like/dislike indicium being representative of whether said user likes or dislikes one of said audio pieces.

3. The method as set forth in claim 2 wherein said playlist is created by an audio content server and said individual audio pieces are transmitted from said audio content server to said audio device.

4. The method as set forth in claim 3 and further including transmitting said like/dislike indicium from said audio device to said content server.

5. The method as set forth in claim 4 wherein said content server is further operable for adjusting content of said playlist in response to said like/dislike indicium received from said audio device.

6. The method as set forth in claim 5 wherein said like/dislike indicium is generated by said user by actuating a switching device on said audio device while one of said audio pieces is playing on said audio device.

7. The method as set forth in claim 1 and further including enabling said user to select channels to be accessed by said content server in creating said playlist.

8. The method as set forth in claim 1 wherein one of said categories is a text website, said method further including translating text on said text website into verbal format for playing as one of said audio pieces on said audio device.

9. A medium containing machine-readable indicia, said machine-readable indicia being executable within a signal processing system for providing control signals for operating a personal media system, said control signals being operable for:
enabling a user of an audio device to select categories of media content preferred by said user; and
transmitting only media pieces within said categories to said media device for playing on said media device.

10. The medium as set forth in claim 9 wherein said media device is an audio device, said media content being comprised of a playlist of individual audio pieces, said control signals being further operable for:
enabling said user to provide a like/dislike indicium while said audio pieces are playing on said audio device, said like/dislike indicium being representative of whether said user likes or dislikes one of said audio pieces.

11. The medium as set forth in claim 10 wherein said playlist is created by an audio content server and said individual audio pieces are transmitted from said audio content server to said audio device.

12. The medium as set forth in claim 11 and further including transmitting said like/dislike indicium from said audio device to said content server.

13. The medium as set forth in claim 12 wherein said content server is further operable for adjusting content of said playlist in response to said like/dislike indicium received from said audio device.

14. The medium as set forth in claim 13 wherein said like/dislike indicium is generated by said user by actuating a switching device on said audio device while one of said audio pieces is playing on said audio device.

15. The medium as set forth in claim 9 wherein said control signals are further operable for enabling said user to select channels to be accessed by said content server in creating said playlist.

16. The medium as set forth in claim 9 wherein one of said categories is a text website, said control signals being further operable for translating text on said text website into verbal format for playing as one of said audio pieces on said audio device.

17. A system for implementing a personal media system, said system comprising:
a media device operable for enabling a user of said media device to select categories of media content preferred by said user;
a media content server coupled to said media device, said media content server being arranged to receive information identifying said categories transmitted from said media device; and
means for transmitting only media pieces within said categories from said media content server to said media device for playing on said media device.

18. The system as set forth in claim 17 wherein said media device is an audio device, said media content being comprised of a playlist of individual audio pieces, said playlist being created by said audio content server in response to said categories of audio content selected by said user.

19. The system as set forth in claim 18 and further including:
means for enabling said user to provide a like/dislike indicium while said audio pieces are playing on said audio device, said like/dislike indicium being representative of whether said user likes or dislikes one of said audio pieces.

20. The system as set forth in claim 19 wherein said playlist is modified by said content server in response to said like/dislike indicium received from said audio device.
